(19) United States
(12) Patent Application Publication
(10) Pub. No.: US 2017/0299418 A1
(43) Pub. Date: Oct. 19, 2017

(54) FUEL GAUGE

(71) Applicant: Zodiac Aerotechnics, Plaisir (FR)

(72) Inventor: Eddy Colombani, Maurepas (FR)

(21) Appl. No.: 15/507,548

(22) PCT Filed: Aug. 31, 2015
(86) PCT No.: PCT/FR2015/052303

§ 371 Date: Feb. 28, 2017

(30) Foreign Application Priority Data
Sep. 1, 2014 (FR) 14 58169

(51) Int. Cl. G01F 23/26

(52) U.S. Cl. CPC G01F 23/268

(57) ABSTRACT

A fuel gauge comprises two cylinders, internal and external respectively, each made of composite material based on electrically conducting fibers, and fixedly placed one inside the other without direct electrical contact between the cylinders, so that a capacity value for a capacitor formed by the cylinders is representative of a fuel level between the cylinders. The external cylinder includes an electrically insulating coating arranged on an external surface of said external cylinder, turned opposite the internal cylinder. The insulating coating of the external cylinder may be of a composite material based on glass fibers.

### CROSS-REFERENCE TO RELATED APPLICATIONS

This application is the U.S. national phase of International Patent Application No. PCT/FR2015/052303, filed on Aug. 31, 2015, which application claims priority to France Patent Application No. 1458169, filed on Sep. 1, 2014, the contents of all of which are incorporated herein by this reference.

### FIELD OF THE INVENTION

The present invention relates to a fuel gauge as well as its method of manufacturing.

### BACKGROUND OF THE INVENTION

It is known to develop a fuel gauge in the form of two cylinders, internal and external respectively, each made of composite material which is based on electrically conducting carbon fibers, and fixedly placed one inside the other without direct electrical contact between the cylinders. Then the capacity value for the capacitor formed by the cylinders is representative of a fuel level existing between the cylinders.

Such gauges have an advantage in terms of weight which is reduced, with respect to gauges having identical geometry and operating principle, but for which the two cylinders are each based on aluminum sheet.

Furthermore, it is also known to develop a fuel gauge in the form of two cylinders each made of a composite material which is based on glass fibers. The internal cylinder then includes a first metallization coating on its external face, and the external cylinder includes a second metallization coating on its internal face. Such fuel gauges also have the advantage of weight reduction, but the two metallization coatings are long and expensive to produce.

However, the fact that the external surface of the external cylinder of the gauge is electrically insulating shows an advantage in terms of security. Indeed, there is then no risk of possibly explosive sparks in cases where this external surface would accidentally contact another electrically conducting member inside the fuel tank. The risk linked to such accidental contact produced with the external surface of the internal cylinder of the gauge is lower, because this other surface is less exposed as it is surrounded by the external cylinder.

To this day, there is still a need for a fuel gauge having simultaneously the three advantages that were just listed: weight reduction, reduced price of manufacturing, and security with respect to an accidental contact with an external member which would be electrically conducting.

### BRIEF SUMMARY OF THE INVENTION

The present invention then has the objective of fulfilling this need.

For this purpose, a first aspect of the invention proposes a fuel gauge still comprising two cylinders, internal and external respectively, each made of a composite material based on electrically conducting fibers which are embedded in a matrix, the internal cylinder being fixedly placed inside the external cylinder without direct electrical contact between the cylinders, so that a capacity value for a capacitor formed by the cylinders is representative of a fuel level existing between the cylinders. In such fuel gauge according to the invention, the external cylinder includes an electrically insulating coating arranged on the external surface of the external cylinder, facing away from the internal cylinder.

Such fuel gauge has a reduced weight, a reduced cost, and the security advantage in cases where an electrically conducting member contacts the external surface of the external cylinder, accidentally inside a fuel tank wherein the gauge has been installed.

In preferred embodiments of the invention, the insulating coating of the external cylinder, on the external surface of the latter, may itself comprise a layer of composite material which is based on electrically insulating fibers embedded in a matrix, which is also electrically insulating. The insulating coating thus formed then participates to the rigidity and strength of the external cylinder. In particular, this composite material of the insulating coating of the external cylinder may be based on glass fibers. Advantageously, the electrically conducting fibers of the composite material of the external cylinder and the electrically insulating fibers of the composite material of the insulating coating may be coated in the form of two superimposed fiber layers in one same matrix which is common to these two layers, in order to form each composite material.

Preferably, the electrically conducting fibers of at least one of the internal and external cylinders may comprise carbon fibers.

Moreover, the fuel gauge may also comprise an electrical block which is electrically connected to the two cylinders, and adapted to produce a signal which is representative of its capacity value. Advantageously, the electrical block may be connected to each cylinder separately by a dedicated electrically conducting pin, each pin being inserted into an electrical terminal which is rigidly fixed onto the corresponding cylinder in electrical contact with this cylinder. Such assembly is particularly reliable during the whole duration of use of the fuel gauge, and allows mounting and dismounting operations which are easy and fast.

In advantageous embodiments, the electrical terminal of the external cylinder may comprise an electrically conducting plate crossing the external cylinder, with the first part of the plate applied against an internal surface of the external cylinder, and the second part of the plate located on the electrically insulating coating in order to receive the pin connecting the electrical block to the external cylinder.

A second aspect of the invention relates to a fuel tank equipped with a fuel gauge in compliance with the first aspect. In particular, such tank may be of aircraft tank type.

A third aspect of the invention relates to a method of manufacturing a fuel gauge, where the fuel gauge comprises two cylinders, internal and external respectively, each made of composite material based on electrically conducting fibers which are embedded in a matrix. The method comprises the following steps executed for each cylinder:
/1/ winding at least one electrically conducting fiber, for example a carbon fiber, on a rotatably driven mandrel;
/2/ thermally processing a matrix material which is arranged for embedding or impregnating the wound fiber, in order to form the composite material; and
/3/ removing the obtained cylinder from the mandrel.

Then the internal cylinder is fixedly placed inside the external cylinder without direct electrical contact between the cylinders, so that the capacity value for a capacitor formed by the cylinders is representative of the fuel level existing between the cylinders.

According to the invention, the method further comprises forming an electrically insulating coating on an external surface of the external cylinder, this external surface of the external cylinder facing against the internal cylinder in the fuel gauge.

Preferably, forming the electrically insulating coating on the external surface of the external cylinder may comprise the following additional steps executed for the external cylinder, after step /1/:
/4/ winding at least one electrically insulating material on the rotatably driven mandrel, above the electrically conducting fiber which is already wound.

In an advantageous manner, this step /4/ may be executed between steps /1/ and /2/, and step /2/ is then executed so as to thermally process the matrix material arranged for embedding or impregnating both the wound electrically conducting fiber and the wound fiber of electrically insulating material, the matrix material being electrically insulating.

A method of manufacturing in compliance with the third aspect of the invention provides a fuel gauge which is itself in compliance with the first aspect of the invention.

### BRIEF DESCRIPTION OF THE DRAWINGS

Other features and advantages of the present invention will appear in the following description of embodiment examples which are not restrictive, in reference to the following accompanying drawings:

FIG. 1 is a perspective view of a fuel gauge in compliance with the invention;

FIG. 2 illustrates a fuel tank equipped with the gauge of FIG. 1; and

FIG. 3 is a magnified and truncated view of part of FIG. 1, under a different perspective direction.

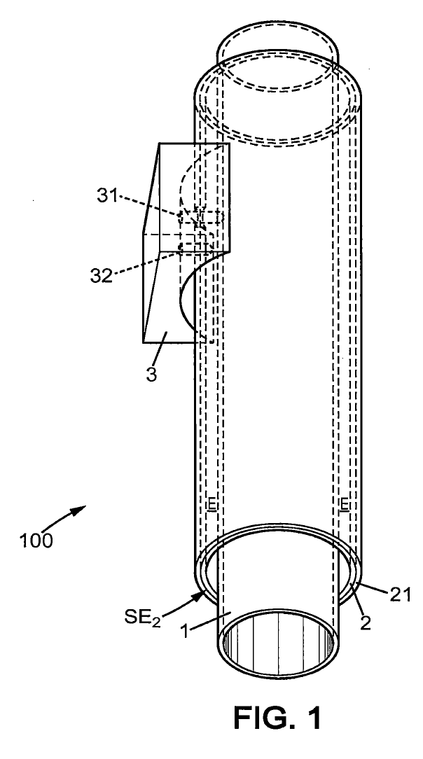

### DETAILED DESCRIPTION

For reasons of clarity, the dimensions of the elements represented in these figures correspond neither to real dimensions nor to real dimension ratios.

The references indicated in the figures have the following meanings:

100 fuel gauge denoted as a whole

1 internal cylinder

2 external cylinder

E intermediate space between cylinders 1 and 2

SE₂ external surface of the external cylinder 2

SI₂ internal surface of the external cylinder 2, against the external surface SE₂

21 insulating coating arranged on the external surface SE₂

3 electrical block

31 pin originating from the electrical block 3 making contact with the internal cylinder 1

32 pin originating from the electrical block 3 making contact with the external cylinder 2

33 terminal contacting the cylinder 1

33a and 33b rivets for fixing the terminal 33 on the cylinder 2

34 terminal for contacting the cylinder 2

34a and 34b rivets for fixing the terminal 34 on the cylinder 2

200 fuel tank

201 upper wall of the tank 200

202 lower wall of the tank 200

203 internal volume of the tank 200, wherein the fuel gauge is rigidly installed

S free surface of the liquid fuel inside the tank 200

The cylinders 1 and 2 may be made of resin-impregnated carbon fibers, for example with epoxy resin. The composite material thus formed is electrically conducting, due to the carbon fibers which are themselves conducting and form an almost continuous frame inside each cylinder. The cylinders 1 and 2 thus each form an armature for an electrical capacitor, with a capacity value depending on the dielectric medium between them. For this purpose, the two cylinders 1 and 2 do not have direct electrical contact with each other, but are maintained one inside the other by appropriate supports (non-represented). For example, the cylinders 1 and 2 may be coaxial. When the gauge 100 thus formed is placed with a determined orientation inside the fuel tank 200 (see FIG. 2), for example a plane fuel tank, the capacity value varies based on the fuel filling level, of the intermediate space E separating the cylinders 1 and 2. In other words, the capacity value varies based on the height of the free surface S between the walls 201 and 202 of the tank. Such capacity operation of the gauge 100 is known, such that it is not required to repeat it.

The external surface SE₂ of the cylinder 2 thus faces against the cylinder 1. The cylinder 2 is covered, on this external surface SE₂, with the electrically insulating coating 21. The coating 21 may have very diverse compositions and embodiments. For example, the coating 21 may be an insulating varnish applied by coating on the cylinder 2 and then dried. According to a preferred embodiment of the coating 21, the latter is also made of composite material, but with a composition making it electrically insulating. For example, the coating 21 may be made of glass fiber impregnated with epoxy resin. Developing of the coating 21 may thus be economic, with steps of manufacturing that are shared with the external cylinder 2.

For example, a carbon fiber is first wound on a mandrel having a diameter corresponding to the internal diameter of the cylinder 2, so as to form a first layer. Then, a glass fiber is wound on a mandrel after the carbon fiber, above the latter, so as to form a second layer. The second fiber layer may then be impregnated with a solution containing epoxy resin monomers, and then are dried. The epoxy resin is hence definitively solidified, and rigidly maintains all the fiber turns made of carbon and glass, in compliance with their initial placements. The mandrel may then be actually extracted. The two layers forming the composite materials of the cylinder 2 and of its coating 21 may respectively each have a thickness of one or a few tenths of millimeters, for example.

In an alternative method of manufacturing the gauge, the fibers used, electrically conducting and/or insulating, may be initially pre-impregnated or embedded with the epoxy resin monomers. In this case, the two fiber layers, made of carbon and glass, may be directly heated after being wound one after the other on the mandrel. The pre-impregnated or embedded fibers are thus transformed into rigid composite materials constituting the external cylinder and its electrically insulating coating.

In the fuel gauge 100, the cylinder 2 fulfils the function of external electrical armature of the capacitor, and the coating 21 forms an external sheath which is electrically insulating for this external armature.

The cylinder 1 may be produced in a way that is similar to that of the cylinder 2, but without necessarily using glass fiber after the carbon fiber. The cylinder 1 fulfils the function of internal electrical armature of the fuel gauge 100.

The electrical block 3 contains an electrical circuit which is electrically connected to the two cylinders 1 and 2. For example, the electrical circuit comprises an RLC-series circuit, where C is the capacity of the capacitor formed by the cylinders 1 and 2, L and R are and fixed inductance and resistance, respectively. The electrical features of such circuit are sensitive to variations in the capacity value C, and therefore to variations in the level of fuel tank 200 filling. Other detection circuit types may be alternatively used. In all cases, at least two electrical connections connect the circuit of the electrical block 3 separately to the cylinder 1 and the cylinder 2. In a preferred manner, these connections may be produced in the form of insertion pins, easy to assemble, and which are particularly reliable throughout the duration of use of the gauge 100.

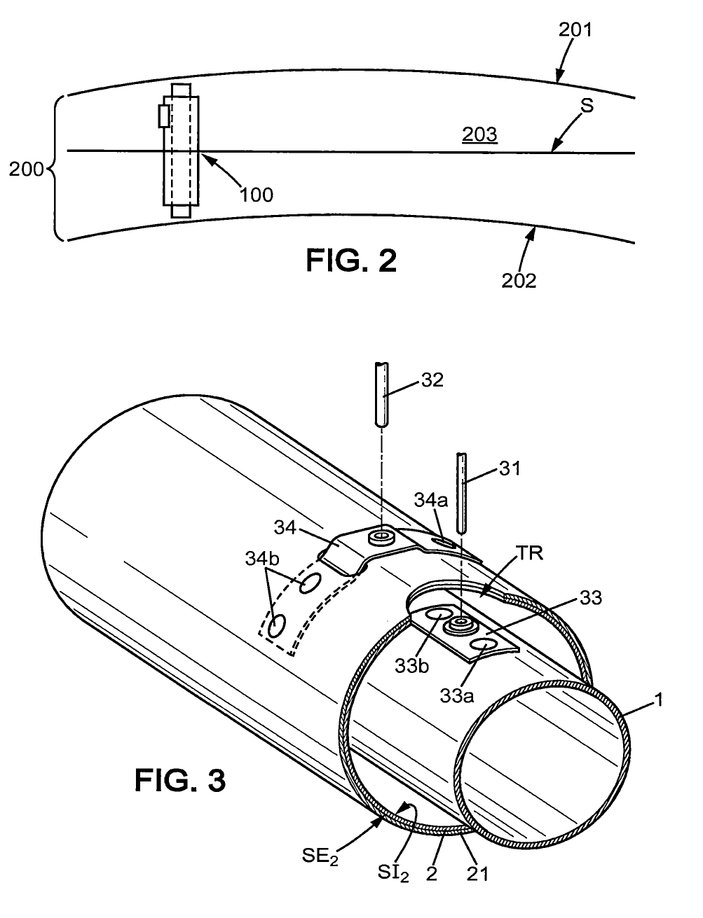

FIG. 3 shows a possible example for connecting the electrical block 3 to the cylinders 1 and 2.

The terminal 33 may be in the form of a metallic plate provided with a calibrated hole for inserting the pin 31. The terminal 33 may be fixed on the external surface of the internal cylinder 1 by rivets 33a and 33b, if the cylinder 1 is not covered with an electrically insulating layer on the surface. A cylindrical hole TR may be provided through the external cylinder 2 and the coating 21, in line with the terminal 33, so that the pin 31 may be introduced through the hole TR and inserted into the terminal 33 without contacting the cylinder 2. Thus, the terminal 31 produces an electrical connection between the electrical block 3 and the internal cylinder 1.

The terminal 34 may also be in the form of a metallic plate provided with a calibrated hole, but for inserting the pin 32 therein. The terminal 34 may be fixed on the external cylinder 2 by rivets 34a and 34b, but part of the metallic plate is arranged inside the cylinder 2, against its internal surface SI₂, so as to produce the electrical contact with the cylinder 2 despite the presence of the insulating coating 21 on the external surface SE₂. Thus, the pin 32 produces an electrical connection between the electrical block 3 and the external cylinder 2.

Fixation modes other than the rivets may be used alternatively for fixing the terminals 33 and 34 onto the cylinders 1 and 2.

The pins 31 and 32 may be rigidly secured to the electrical block 3, so that the connection of the block 3 to cylinders 1 and 2 may be operated simply by pressing onto the block 3, to insert simultaneously the two pins 31 and 32 into the terminals 33 and 34. Potentially, the pins 31 and 32 may have different diameters, to impose a direction of determined connection.

Of course, other practical methods may be implemented alternatively, to electrically connect the electrical block 3 to the cylinders 1 and 2, through the insulating coating 21 introduced by the invention.

Finally, electrically conducting fibers other than the carbon fibers may be used alternatively to form the internal and/or external cylinders. Likewise, the epoxy resin taken as an example may be replaced with any other matrix material, being electrically insulating when it participates to the composition of the external cylinder coating.

1. A fuel gauge comprising two cylinders, internal and external respectively, each made of composite material based on electrically conducting fibers which are embedded in a matrix, the internal cylinder being fixedly placed inside the external cylinder without direct electrical contact between the cylinders, so that a capacity value for a capacitor formed by the cylinders is representative of a fuel level existing between said cylinders,
characterized in that the external cylinder includes an electrically insulating coating arranged on an external surface of said external cylinder, facing against the internal cylinder.

2. The fuel gauge according to claim 1, wherein the insulating coating comprises itself a layer of composite material based on electrically insulating fibers embedded in a matrix which is also electrically insulating.

3. The fuel gauge according to claim 2, wherein the composite material of the insulating coating of the external cylinder, is based on glass fibers.

4. The fuel gauge according to claim 2, wherein the electrically conducting fibers of the composite material of the external cylinder and the electrically insulating fibers of the composite material of the insulating coating are embedded in a form of two superimposed layers of fibers in one same matrix that is common to said two layers, to form each composite material.

5. The fuel gauge according to claim 1, wherein the electrically conducting fibers of at least one of the internal and external cylinders comprise carbon fibers.

6. The fuel gauge according to claim 1, further comprising an electrical block electrically connected to the two cylinders, and adapted to produce a signal representative of the capacity value,
and wherein the electrical block (3) is connected to each cylinder separately by an electrically conducting pin, each pin being inserted into an electrical terminal which is rigidly fixed onto the corresponding cylinder and in electrical contact with said cylinder.

7. The fuel gauge according to claim 6, wherein the electrical terminal of the external cylinder comprises an electrically conducting plate which crosses said external cylinder, with a first part of the plate which is applied against an internal surface of the external cylinder, and a second part of plate which is located on the electrically insulating coating to receive the pin which connects the electrical block to the external cylinder.

8. A fuel tank, equipped with a fuel gauge in compliance with claim 7.

9. The fuel tank according to claim 8, of aircraft tank type.

10. A method of manufacturing a fuel gauge, wherein the fuel gauge comprises two cylinders, internal and external respectively, each made of composite material based on electrically conducting fibers embedded in a matrix, the method comprising the following steps executed for each cylinder:
/1/ winding at least one electrically conducting fiber on a rotatably driven mandrel;
/2/ thermally processing a matrix material arranged for embedding or impregnating the wound fiber, to form the composite material;
/3/ removing the obtained cylinder from the mandrel; and
placing the internal cylinder fixedly inside the external cylinder without direct electrical contact between the cylinders, so that a capacity value for a capacitor formed by said cylinders is representative of a fuel level between said cylinders,
characterized in that the method of manufacturing further comprises forming an electrically insulating coating on an external surface of the external cylinder, said external surface of the external cylinder facing against the internal cylinder (1) inside the fuel gauge.

11. The method of manufacturing according to claim 10, wherein forming the electrically insulating coating on the external surface of the external cylinder, comprises the following additional steps executed for said external cylinder, after step /1/:
/4/ winding at least one fiber of electrically insulating material fiber onto the rotatably driven mandrel, above the electrically conducting fiber which is already wound.

12. The method of manufacturing according to claim 11, according to which step /4/ is executed between steps /1/ and /2/ for the external cylinder, and step /2/ is executed so as to thermally process the matrix material which is arranged for embedding or impregnating both the electrically conducting fiber wound and the wound fiber of electrically insulating material, said matrix material being electrically insulating.
